(19) United States
(12) Patent Application Publication
(10) Pub. No.: US 2026/0300043 A1
(43) Pub. Date: Oct. 1, 2026

(54) DEVICE AND METHOD FOR REAL-TIME AND LIGHTWEIGHT GPU WORKLOAD TRACING AND BOTTLENECK ANALYSIS

(71) Applicant: KOREA UNIVERSITY RESEARCH AND BUSINESS FOUNDATION, Seoul (KR)

(72) Inventors: Minchul KANG, Seoul (KR); Younghun GO, Seoul (KR); Chuck YOO, Seoul (KR); Gyeongsik YANG, Seoul (KR)

(21) Appl. No.: 19/531,439

(22) Filed: Feb. 5, 2026

(30) Foreign Application Priority Data
Apr. 1, 2025 (KR) 10-2025-0041946

(51) Int. Cl. G06F 9/54; G06F 9/48

(52) U.S. Cl. CPC G06F 9/541; G06F 9/4881

(57) ABSTRACT

Disclosed is a device and method for real-time lightweight graphics processing unit (GPU) workload tracing and bottleneck detection. A GPU workload tracing and bottleneck detection method performed by a computing device including a processor may include executing the GPU workload, acquiring application programming interface (API) argument information by hooking a predetermined API during execution of the GPU workload, and detecting a bottleneck phenomenon using the acquired argument information.

### CROSS-REFERENCE TO RELATED APPLICATION(S)

This application claims the benefit under 35 USC § 119(a) of Korean Patent Application No. 10-2025-0041946 filed on Apr. 1, 2025 in the Korean Intellectual Property Office, the entire disclosure of which is incorporated herein by reference for all purposes.

### BACKGROUND

### 1. Field

The present invention relates to graphics processing unit (GPU) performance analysis technology for tracing GPU workload in real time and quickly diagnosing a bottleneck, and more particularly, to a device and method for detecting a bottleneck with low overhead without code modification for workload by dynamically hooking a Compute Unified Device Architecture (CUDA) driver application programming interface (API) and an NVIDIA Collective Communications Library (NCCL) API utilizing extended Berkeley Packet Filter (eBPF).

### 2. Description of Related Art

Large-scale graphics processing unit (GPU) workload, such as training a deep learning model, requires a long computational time and high cost. Therefore, a tracing technique for a complexity and computational process of GPU workload is essential to quickly identify a performance bottleneck point and to gain insight into optimization. However, the existing GPU workload tracing technique 1) requires code modification of workload, 2) causes high overhead during a tracing process, or 3) does not provide a real-time tracing feature.

If the profiling overhead is excessively high, it may cause performance degradation. If real-time workload tracing is not possible, it is difficult to utilize massive workload tracing information for system optimization, such as real-time bottleneck diagnosis.

Therefore, the present invention develops a real-time, lightweight GPU workload tracing tool, and particularly, proposes a tracing and/or bottleneck detection technique (named gpubpf) specialized for GPU workload using extended Berkeley Packet Filter (eBPF) that may lightly trace characteristics of workload.

The proposed technique (gpubpf) traces the total number of threads to be executed on a GPU, the GPU memory transmission and reception data size, and the inter-GPU communication data size. In particular, the present invention may trace workload 1) without code modification, 2) with low overhead, and 3) in real time by dynamically hooking Compute Unified Device Architecture (CUDA) driver application programming interface (API) and NVIDIA Collective Communications Library (NCCL) API arguments. The proposed technique (gpubpf) may simultaneously trace more than 50 types of APIs without missing and with very low overhead of about 0.4%.

### SUMMARY

A technical subject to be achieved by the present invention is to trace large-scale graphics processing unit (GPU) workload in real time with low overhead without code modification. Existing GPU tracing tools either require direct code modification of workload, incur high overhead, or lack a real-time tracing feature.

For example, NVIDIA Compute Unified Device Architecture (CUDA) Profiling Tools Interface (CUPTI) may perform real-time workload tracing with relatively low overhead, but requires direct code modification of GPU workload. Nsight Compute (ncu) and Nsight Systems (Nsys) among other representative GPU workload tracing tools do not require code modification of workload, but have relatively high tracing overhead and do not provide the real-time tracing feature. The significantly high profiling overhead causes performance degradation. When real-time tracing is impossible, real-time decision of massive workload tracing information may be difficult. In particular, these limitations are even more pronounced in tasks, such as deep learning, which require a long computational time and high cost. That is, tools for tracing GPU workload in real time with low overhead without code modification are currently lacking.

A GPU workload tracing and bottleneck detection method performed by a computing device including a processor according to an example embodiment includes executing GPU workload, acquiring application programming interface (API) argument information by hooking a predetermined API during execution of the GPU workload, and detecting a bottleneck phenomenon using the acquired argument information.

The present invention proposes a technique for tracing GPU workload in real time with low overhead without code modification based on extended Berkeley Packet Filter (eBPF), thereby solving issues of high overhead and lack of real-time performance, or inconvenience of code modification, which appear in the existing tracing tools.

Specifically, by hooking core operations of GPU workload represented by a Compute Unified Device Architecture (CUDA) driver API and an NVIDIA Collective Communications Library (NCCL) API, based on eBPF, and by recording tracing information of the core operations of the GPU workload in a buffer within a kernel, it is possible to dynamically trace information, such as the total number of threads to be executed on a GPU without code modification, a memory transmission and reception amount, and an inter-GPU communication amount.

This allows for system optimization, such as real-time bottleneck diagnosis, without degradation in the performance of GPU workload, and provides effective technology that may be practically utilized in various GPU-based computing environments, such as an artificial intelligence (AI) cloud platform and high-performance computing (HPC).

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates cuLaunchKernel and cuMemcpy signatures;

FIG. 2 illustrates ncclSend and ncclRecv signatures;

FIG. 3 illustrates the design of a proposed technique;

FIG. 4 illustrates an execution screen of a proposed technique;

FIG. 5 illustrates overhead comparison results between techniques; and

FIG. 6 illustrates a flowchart illustrating a GPU workload tracing and bottleneck detection method according to an example embodiment.

### DETAILED DESCRIPTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Hereinafter, example embodiments will be described with reference to the accompanying drawings. However, the scope of the patent application is not limited to or restricted by such example embodiments. Like reference numerals used herein refer to like elements throughout.

Initially, terms used herein are explained.

Kernel: The kernel is a core component of an operating system (OS), and serves as an interface between hardware and application software. The kernel is responsible for overall key system features, such as process management, memory management, device driver, network stack, and file system management.

Graphics processing unit (GPU) kernel: The GPU kernel is a computational function designed to perform parallel processing in a GPU's multithread environment. A single GPU kernel is executed simultaneously across multiple threads based on a grid and block structure. In general, it is often referred to as a kernel, but the GPU kernel is used herein to avoid confusion with the term “kernel of the operating system” described above.

Hooking: Hooking is a technique for interrupting or modifying the execution flow of a code to intercept or expand the operation of a specific function or event. It is primarily used for debugging, performance measurement, and security monitoring.

Tracing: Tracing is a technique for recording and analyzing the operating status of a system, and used to identify a bottleneck section or to optimize the performance. Tracing may be performed at the kernel or application level, and a real-time tracing tool, such as extended Berkeley Packet Filter (eBPF), may process the large volume of events with low overhead.

GPU workload typically operates by repeatedly calling a plurality of Compute Unified Device Architecture (CUDA) driver application programming interfaces (APIs) and NVIDIA Collective Communications Library (NCCL) APIs in a driving process. Here, various types of APIs are called.

Compute Unified Device Architecture (CUDA) is NVIDIA's programming model, and provides a CUDA driver API that manages the GPU workload. NVIDIA's GPU may perform operations based on these CUDA driver API calls, may allocate and release GPU memory, or may copy and/or move data.

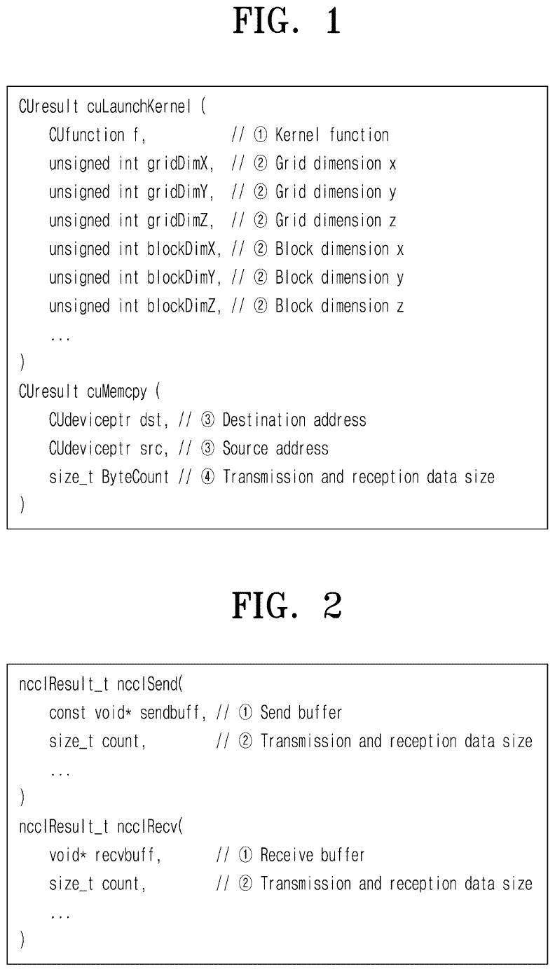

FIG. 1 illustrates cuLaunchKernel and cuMemcpy that are representative CUDA driver APIs. That is, cuLaunchKernel and cuMemcpy correspond to representative CUDA driver APIs that are most frequently and repeatedly called, and their signatures are illustrated in FIG. 1.

The cuLaunchKernel API is an API that calls a GPU kernel to be executed on a specific GPU, and a function signature illustrated in top of FIG. 1. cuLaunchKernel receives, as arguments, 3D grid dimension information and block dimension information in addition to a GPU kernel function to be executed. That is, the kernel function (\textcircled{1}) to be executed on the GPU and the number of dimensions of grid and block (\textcircled{2}) are included in the arguments. Hardware threads to be executed in parallel within the GPU are represented as a set of blocks in a multi-dimensional form, and the blocks are represented as a set of grids in a multidimensional form. That is, a block may represent a set of a plurality of hardware threads driven by the GPU, and a grid may represent a set of a plurality of blocks. Therefore, when 3D grid (gridDim.x,gridDim.y,gridDim.z) and block (blockDim.x,blockDim.y,blockDim.z) are given, the total number of threads to be executed by the GPU may be calculated as shown in Equation 1.

$$total thread = gridDim . x \times gridDim . y \times gridDim . z \times blockDim . x \times blockDim . y \times blockDim . z \qquad [ Equation 1 ]$$

The cuMemcpy API is used to copy data between a GPU and a central processing unit (CPU), and is frequently called primarily in a situation in which computational data (or memory data) is transmitted and received between the CPU and the GPU. Its signature is illustrated in bottom of FIG. 1. Also, transmission (destination) and reception (source) addresses (\textcircled{3}) and transmission and reception data sizes (\textcircled{4}) are included in arguments. CUDA driver APIs related to memory operations that perform data copy operations with the same or similar arguments as cudaMemcpy include cuMemcpy, cuMemcpyAtoA, cuMemcpyAtoD, cuMemcpyAtoH, cuMemcpyDtoA, cuMemcpyDtoD, cuMemcpyDtoH, cuMemcpyHtoA, cuMemcpyHtoD, and cuMemcpyPeer.

The NVIDIA Collective Communications Library (NCCL) is NVIDIA's library that supports efficient data communication between a plurality of GPUs, and is widely used in distributed deep learning environments in which two or more GPUs are utilized. The NCCL supports group communication operations, such as AllReduce, AllGather, Broadcast, Reduce, and ReduceScatter, and abstracts complex tasks typically involved in inter-GPU data transmission at the library level and provides a user with a simple API.

FIG. 2 illustrates ncclSend and ncclRecv that are representative NCCL APIs. Two APIs include a transmission/reception buffer (\textcircled{1}) and a transmission and reception data size (\textcircled{2}). In addition, there are various NCCL APIs that specify the data size as an argument, such as ncclAllReduce and ncclBroadcast.

An extended Berkeley Packet Filter (eBPF) is a Linux kernel technique that enables safe and fast execution of eBPF programs within a kernel area. An eBPF program refers to a piece of code that is executed in response to various events (e.g., system call, kprobe, uprobe, tracepoint, etc.) within the kernel space, and enables real-time code tracing and control. The eBPF program may be attached to various event sources, such as a kernel's tracepoint and probe (kprobe, uprobe). When an event occurs, the eBPF program may be executed to perform an intended action. That is, the user may trigger execution of a desired program that is executed within the kernel by attaching the program to a specific event.

Since the eBPF program runs within the kernel, it is possible to reduce unnecessary context switching cost, enabling fast execution with low overhead. Therefore, the eBPF program is being used for performance optimization and real-time monitoring in the wide range of areas including network monitoring, security, and system optimization.

The present invention attaches the eBPF program to API call events of core operations within GPU workload, such as cuLaunchKernel, cuMemcpy, ncclSend, and ncclRecv, and traces an API argument being called in real time. For example, when calling cuLaunchKernel, the eBPF program hooks argument information of called cuLaunchKernel, and calculates and records the total number of threads to be executed on the GPU based on the hooked argument information. Similarly, when calling cuMemcpy, transmission and reception data size and address information are traced and recorded in real time, and when calling ncclSend, transmission and reception buffer and data size are traced and recorded in real time.

GPU workload tracing tools proposed to date have their own strengths and limitations. Table 1 compares existing tools in terms of necessity of code modification, overhead, and real-time tracing capability.

TABLE 1

| | | |
|---|---|---|
| CUPTI | ncu | nsys |

| | | |
|---|---|---|
| Code modification | Necessary | Not necessary |
| Overhead | Low | High |
| Real-time | Possible | Impossible |

CUPTI provides a real-time tracing feature with relatively low overhead, but requires code modification of workload, whereas Nsight Compute (ncu) and Nsight Systems (nsys) enable workload tracing without code modification of workload. However, ncu and nsys involve high overhead for profiling, and do not provide the real-time tracing feature. That is, the tools proposed to date may 1) not trace workload in real time 2) with low overhead and 3) without code modification.

Currently, eBPF-based real-time, high-performance system tracing studies have been actively conducted. XRP improved the I/O request performance of a non-volatile memory express (NVMe) driver by hooking an interrupt handler of the NVMe driver using the eBPF and by directly executing a user-defined storage function within the kernel. Electrode significantly reduced the context switching cost and overhead of going through a networking stack by hooking operations of a distributed protocol using the eBPF and then directly executing the same within the kernel. DINT improved the performance of a transaction server by directly processing core operations of the transaction server, such as lock management and key-value storage, within the kernel using XDP that is eBPF-based packet processing technology.

In summary, the eBPF has been widely used for real-time, high-performance system tracing. However, the eBPF has not been used to trace GPU execution, which is the core of recent high-performance computing.

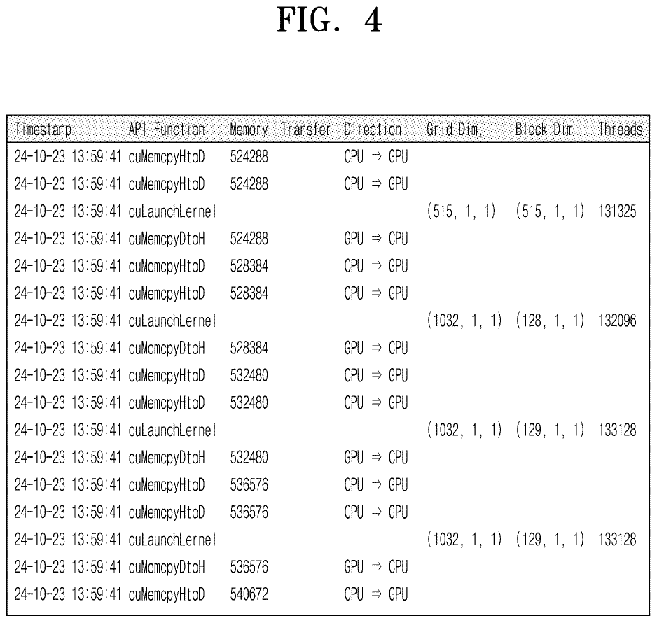

The present invention proposes gpubpf that is a tool for tracking GPU workload in real time based on the eBPF. The proposed technique (gpubpf) may trace GPU workload and diagnose bottleneck with low overhead without code modification by hooking CUDA driver API and NCCL API calls and directly recording the same in the buffer within the kernel. FIG. 4 illustrates the operation of the proposed technique (gpubpf).

The proposed technique (gpubpf) attaches at least one eBPF program to at least one of 1) cuLaunchKernel, 2) 14 types of memory-related CUDA driver APIs including cuMemcpy, and 3) eight types of NCCL communication APIs including ncclAllReduce. However, the number of APIs to which the eBPF program is attached may vary depending on an administrator's selection or environment.

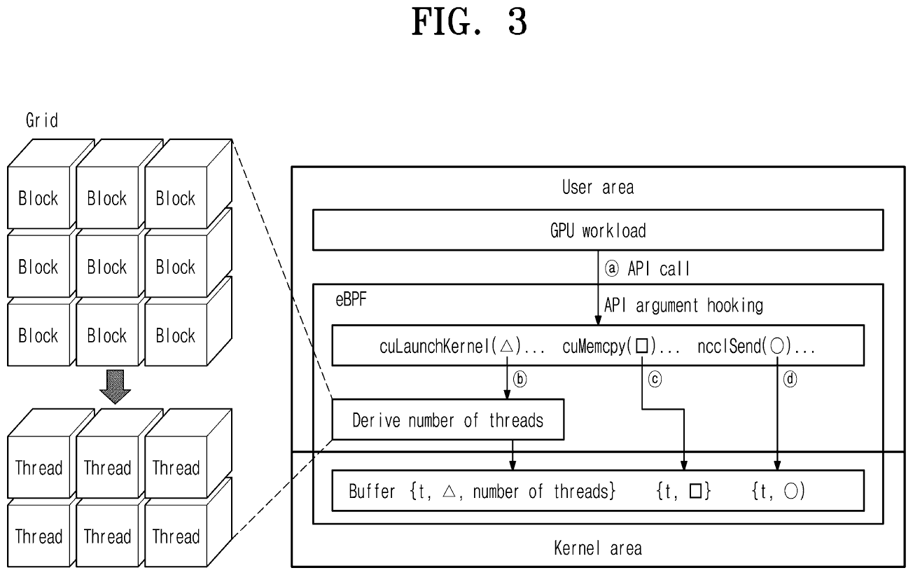

Referring to FIG. 3 illustrating the design of the proposed technique (gpubpf), each eBPF program is triggered to run in response to an API call (\textcircled{a}). When cuLaunchKernel is called, the eBPF program hooks arguments, calculates the total number of threads to be executed based on Equation 1, and directly records the calculated total number of threads in the pre-allocated buffer within the kernel along with timestamp t (\textcircled{b}). Even when the memory-related CUDA driver API and/or NCCL communication API are called, each eBPF program hooks arguments and then acquires memory transmission and reception amount and/or GPU communication amount and records the same in the buffer within the kernel along the timestamp t (\textcircled{c},\textcircled{d}).

Since the eBPF operates within the kernel, the overhead coming from context switching may be dramatically reduced, separate modification of a user code may not be required, and information on GPU workload may be traced in real time. The provides an analytical foundation for optimizing system resource utilization.

The present invention proposes an algorithm for detecting a bottleneck occurrence status in real time based on the proposed technique (gpubpf). The algorithm is as follows.

[Algorithm]
Dynamic Bottleneck Analysis using gpubpf

| | |
|---|---|
| 1: | Initialize thresholds: threadThreshold, memCapacity, |
| | commThreshold |
| 2: | Initialize logList to store detected bottlenecks |
| 3: | while GPU workload is running do |
| 4: | event ← gpubpf.FetchEvent( ) |
| 5: | if event.type = KERNEL_CALL then |
| 6: | totalThreads ← CalculateThreadCount(event) |
| 7: | if totalThreads > threadThreshold then |
| 8: | RecordBottleneck(logList, timestamp, |
| | “Kernel Overload”) |
| 9: | end if |
| 10: | else if event.type = MEM_TRANSFER then |
| 11: | dataSize ← even.dataSize |
| 12: | if dataSize > memCapacity then |
| 13: | RecordBottleneck(logList, timestamp, “Memory |
| | Bottleneck”) |
| 14: | end if |
| 15: | else if event.type = NCCL_OP then |
| 16: | commVolume ← event.commSize |
| 17: | if commVolume > commThreshold then |
| 18: | RecordBottleneck(logList, timestamp, “Comm |
| | Congestion”) |
| 19: | end if |
| 20: | end if |
| 21: | threadThreshold ← CalculateAvgThreads( ) |
| 22: | memCapacity ← CalculateRemainingMemory( ) |
| 23: | commThreshold ← CalculateAvgCommSize( ) |
| 24: | end while |
| 25: | return logList |

In the process of tracing a GPU kernel call (KERNEL_CALL) based on the proposed technique (gpubpf), if the total number of threads to be executed on a specific GPU kernel exceeds the average number of threads executed during a unit time (threadThreshold), it is determined that the corresponding GPU kernel may cause a bottleneck and the corresponding kernel function is recorded along with a timestamp.

Also, if the size of memory data transmitted and received in the process of tracing memory transmission (MEM_TRANSFER) operations exceeds a remaining GPU memory size, it indicates the memory bottleneck probability. Also, if the amount of communication transmitted and received during a unit time while tracing NCCL communication (NCCL_OP) operations exceeds an average value (commThreshold), the bottleneck is considered to be likely to occur.

### Experiment and Analysis

The environment in which a GPU workload tracing experiment was performed using the proposed technique (gpubpf) is shown in Table 2. The experiment utilizes the sendrecv_perf benchmark of nccl-tests. Two V100 GPUs 2 on a single node traced the workload that exchanged data three times from a minimum of 8 bytes to a maximum of 128 MB.

TABLE 2

| Device/software | Spec/version |
|---|---|
| NVIDIA driver | 550.67 |
| CUDA/NCCL version | 11.1.0/2.15.5 |
| Operating system | Ubuntu 18.04.6 LTS |
| Linux kernel | 5.4.0-150 |
| CPU | Intel(R) Xeon(R) Silver 4210 |
| | CPU 40 cores |
| Memory | DDR4 128 GB |

The proposed technique (gpubpf) traced all the called CUDA driver/NCCL API made in the experiment without massing any. Even in the extended experiment of simultaneously tracing 50 or more types of APIs, missing-free tracing was possible, demonstrating the high real-time performance of the proposed technique (gpubpf).

Equation 2 represents the overhead percentage.

$$overhead ( tool ) = ( tracked time ( tool ) - untracked time ) \times 100 / ( untracked time ) \qquad [ Equation 2 ]$$

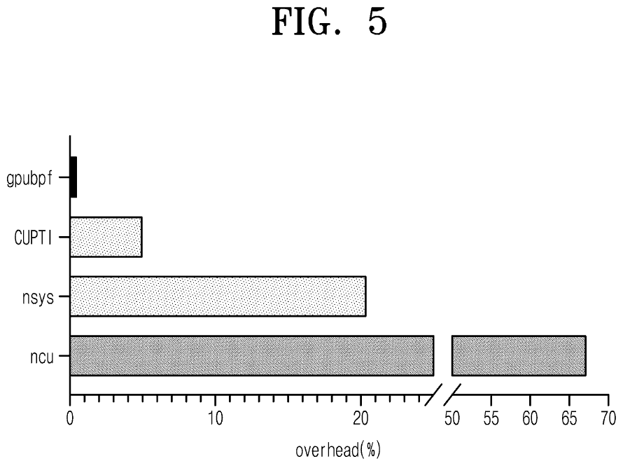

FIG. 5 illustrates an overhead comparison graph based on Equation 2, and compares a workload execution time measured without a tracing tool (untracked time) and a workload execution time measured with a tracing tool (tracked time). The value of the proposed technique (gpubpf) is about 0.4%, which is close to an amount of time required without tracing. This is a value significantly lower than CUPTI that requires code modification or nsys and ncu that are difficult to perform real-time tracing.

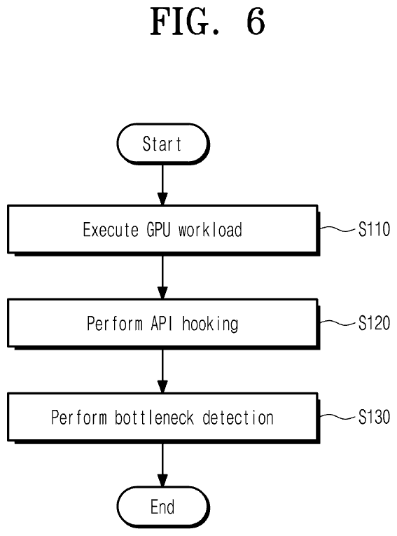

FIG. 6 is a flowchart illustrating a GPU workload tracing and bottleneck detection method according to an example embodiment.

Referring to FIG. 6, the method may be performed by a computing device including at least a processor and/or a memory. That is, at least some of operations included in the method may be understood as an action of the processor included in the computing device. In this case, the computing device may be referred to as a tracing and bottleneck detection device. The computing device may include a personal computer (PC), a server, a tablet PC, and a laptop computer. Depending on example embodiments, the computing device may be implemented as a single device, or may be implemented as a plurality of devices to construct a distributed environment. In describing the method below, further description related to the overlapping content of the aforementioned description is omitted.

In operation S110, GPU workload, such as training of a distributed deep learning model, is executed. The GPU workload may be received from a separate device or server through a wired/wireless communication network, may be received from a storage device such as a universal serial bus (USB) memory device through an I/O interface, or may be prestored in a computing device.

In operation S120, at least one type of API may be hooked during execution of the GPU workload. It may be understood as hooking arguments of the API. Types of APIs that are hooked may include 1) APIs that include a GPU kernel function, a grid dimension, and block dimension as arguments as a first type (e.g., cuLaunchKernel), 2) APIs that include at least transmission and reception data size (GPU memory transmission and reception amount) as an argument as a second type (e.g., cuMemcpy, cuMemcpyAtoA, cuMemcpyAtoD, cuMemcpyAtoH, cuMemcpyDtoA, cuMemcpyDtoD, cuMemcpyDtoH, cuMemcpyHtoA, cuMemcpyHtoD, cuMemcpyPeer, etc.), and 3) APIs that include the transmission and reception data size (GPU communication amount) as an argumenta as a third type (e.g., ncclSend, ncclRecv, ncclAllReduce, ncclBroadcast, etc.).

When the first type of API is hooked, the total number of threads for each timestamp may be additionally calculated based on hooked information (API arguments). The total number of threads may be calculated for each GPU, and may be calculated through Equation 1.

Also, hooking may be performed by attaching an eBPF program to an event source (e.g., API call event) of an API to be hooked.

In operation S130, the bottleneck status is detected. The bottleneck detection is differently performed for each API type. If the first type of API is hooked and the total number of threads during a unit time calculated for each GPU exceeds a first threshold (threadThreshold), a bottleneck phenomenon may be determined to have occurred on the corresponding GPU.

If the second type of API is hooked and the memory transmission and reception amount (transmission and reception data size) exceeds a remaining GPU memory size (or value acquired by applying predetermined weight (weight is real number greater than or equal to 0 or less than or equal to 1) to remaining GPU memory size), the bottleneck phenomenon may be determined to have occurred.

If the third type of API is hooked and the communication amount (GPU communication amount) transmitted and received during a unit time exceeds a second threshold, the bottleneck phenomenon may be determined to have occurred.

The aforementioned bottleneck status detection may be performed for at least one of API types, or may be performed for all of three API types. Also, the first threshold, the weight, and the second threshold may be predefined by the user or the administrator.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

Although the present invention is described with reference to the example embodiments illustrated in the drawings, it is provided as an example only and it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A graphics processing unit (GPU) workload tracing and bottleneck detection method performed by a computing device including a processor, the method comprising:
executing the GPU workload;
acquiring application programming interface (API) argument information by hooking a predetermined API during execution of the GPU workload; and
detecting a bottleneck phenomenon using the acquired argument information.

2. The method of claim 1, wherein the predetermined API includes a first type of API that includes a GPU kernel function, a grid dimension, and a block dimension as arguments.

3. The method of claim 2, wherein the first type of API is cuLaunchKernel.

4. The method of claim 3, wherein the predetermined API includes a second type of API that includes a GPU memory transmission and reception amount as an argument.

5. The method of claim 4, wherein the second type of API includes at least one of cuMemcpy, cuMemcpyAtoA, cuMemcpyAtoD, cuMemcpyAtoH, cuMemcpyDtoA, cuMemcpyDtoD, cuMemcpyDtoH, cuMemcpyHtoA, cuMemcpyHtoD, and cuMemcpyPeer.

6. The method of claim 5, wherein the predetermined API includes a third type of API that includes a GPU communication amount as an argument.

7. The method of claim 6, wherein the third type of API includes at least one of ncclSend, ncclRecv, ncclAllReduce, and ncclBroadcast.

8. The method of claim 7, wherein the acquiring of the API argument information comprises hooking the predetermined API according to execution of an extended Berkeley Packet Filter (eBPF) program attached to a call event of the predetermined API, which is triggered by the call event of the predetermined API that occurs during execution of the GPU workload.

9. The method of claim 8, wherein the detecting of the bottleneck phenomenon comprises determining that the bottleneck phenomenon occurred if the total number of threads of the GPU kernel calculated based on argument information acquired by hooking of the first type of API exceeds a first threshold.

10. The method of claim 9, wherein the detecting of the bottleneck phenomenon comprises determining that the bottleneck phenomenon occurred if the GPU memory transmission and reception amount acquired by hooking of the second type of API exceeds a GPU memory size.

11. The method of claim 10, wherein the detecting of the bottleneck phenomenon comprises determining that the bottleneck phenomenon occurred if the GPU communication amount acquired by hooking of the third type of API exceeds a second threshold.
